(19) United States
(12) Patent Application Publication
(10) Pub. No.: US 2022/0220757 A1
(43) Pub. Date: Jul. 14, 2022

(54) SMALL, AFFORDABLE, NATURAL, ENERGY-EFFICIENT (SANE) HOME

(71) Applicant: Michael R. Weekes, Orlando, FL (US)

(72) Inventor: Michael R. Weekes, Orlando, FL (US)

(21) Appl. No.: 17/574,853

(22) Filed: Jan. 13, 2022

Related U.S. Application Data
(60) Provisional application No. 63/136,733, filed on Jan. 13, 2021.

(51) Int. Cl. E04H 1/02; E04B 1/74

(52) U.S. Cl. CPC E04H 1/02; E04B 2001/742; E04B 1/74

(57) ABSTRACT

Described herein is a new methodology for the manufacture of smaller homes, made from sustainable materials to provide a “green,” low carbon footprint process, wherein less skill is required by the builder(s) utilizing digital technology employed in the manufacture of planes, trains, automobiles, boats and ships.

### TECHNICAL FIELD

The subject matter disclosed herein is generally directed to a new methodology for the manufacture of smaller homes, mobile and affixed to the ground via a foundation made from sustainable, regionally sourced materials to provide a “green,” low carbon footprint process, wherein less skill is required by the builder(s) utilizing digital technology employed in the manufacture of planes, trains, automobiles, boats and ships.

### BACKGROUND

The typical residential single family structure built in the United States has a mean living area of 2,400 sq. ft. It takes up to nine months to construct. The supply chain for residential housing materials has recently been disrupted in a major way, causing further delays and exponential growth in materials costs.

It has a mean cost of $169/sq. ft.; priced at approximately $374,400. This price equates to a mortgage qualification that excludes a great deal of the United States population. In lieu of not being able to qualify for a mortgage, these Americans are forced to rent, sometimes at very expensive rates, for frequently unsafe or unsanitary housing. Without the primary needs of a safe, sanitary place to live, of excessive rental cost, residents, especially those below 80% of the median family income (of $68,703) have to spend up to and above 50% of their take home pay on rent, often sacrificing other primary needs, nutrition, healthcare, maintenance, utility, fuel, other costs. Further, rental prices are growing exponentially.

Exponential growth in the frequency and magnitude of climate-driven catastrophes (tornadoes, hurricanes, fires, landslides, storm surge, etc.) had left our nation without quickly deployable, reliable hosing to achieve safe, sanitary housing. A smaller home of approximately 400 sq. ft., manufactured in a low carbon footprint methodology, leveraging digital technology, advanced manufacturing and living wage labor can deploy smaller homes that cost less to own, requiring a fraction of the cost to operate. However, smaller homes are less desirable to conventional builders as they represent lower profits and lower profit percentages.

By using data and computer-controlled design and manufacturing files and computer-numerical controlled equipment (advanced manufacturing) we can make houses from kits, the same way we build cars, planes and ships.

Research and development among US Colleges and Universities as well as educational institutions in the United Kingdom and The Netherlands have been revealing the value of new methods in manufacturing residential single-family homes, which represent lower costs to build, operate and even make their own required energy.

This application provides a new methodology in the manufacture of a “small home,” made from more sustainable materials, in a green, low carbon footprint process, with less skill required by the builder utilizing digital technology used in the manufacture of planes, trains, automobiles and boats and ships.

Citation or identification of any document in this application is not an admission that such a document is available as prior art to the present disclosure.

### SUMMARY

The above objectives are accomplished according to the present disclosure by an engineered small home. The home may include one living room formed on a floor of the engineered small home, an elevated bathroom raised above the living room, an elevated kitchen raised above the living room, a loft connected to the living room via stairs and raised above the living room, elevated kitchen and elevated bathroom, the loft, bathroom and kitchen are attached to an inner perimeter of the engineered small home and the living room, loft, bathroom, and kitchen are interconnected without being separated by hallways. Further, the engineered small home comprises a slanted roof with an exterior front wall higher than an exterior rear wall and the slanted roof running between the exterior front wall and the exterior rear wall. Next, an exterior of the engineered small home measures no more than sixteen feet in length, width and height. Still, the exterior rear wall is window free to reduce solar heat load. Further yet, the exterior rear wall is oriented to face South and orients the slanted roof to face South. Still yet, the exterior front wall containing at least one window. Yet again, the elevated bathroom and elevated kitchen include storage spaces below each adjacent to a floor of the engineered small home. Again, the home may include a 9,200 BTU cooling and 8,500 BTU heating capacity terminal air conditioner. Still yet, the home may include a wrap covering the floor, all walls, and the roof to create a substantially air-tight envelope. Furthermore, the home may include insulation comprising Boron to deter bugs, rodents, germs and mold. Yet again, at least one solar panel may be placed on the slanted roof running a length of the slanted roof. Still yet, the at least one solar panel powers a hot water system for the engineered small home. Further again, at least one wall may be formed from at least one tile creating a tiled pattern on the at least one wall. Still moreover, the at least one tile is multilayered to form a multilayered stack configuration. Again, the multilayered stack configuration composition may vary from one environ to another environ to adjust the engineered small home to an environ where it is placed.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows one embodiment of a smaller home of the current disclosure.

FIG. 2 shows a top down view of an exemplary floor plan of a smaller home of the current disclosure.

FIG. 3 shows a rear view of a smaller home of the current disclosure.

FIG. 4 shows an close-up view of dome shape with one tile removed from tiled pattern revealing tile holding space.

FIG. 5 shows an exploded view of a tile of the current disclosure.

FIG. 6 shows an alternate embodiment of a wall that may be employed for a differently shaped smaller home.

FIG. 7 shows alternative smaller home which may have larger dimensions.

FIG. 8 shows a further smaller home embodiment.

FIG. 9 shows an alternative floor plan for a traditional framed sane home.

FIG. 10 shows a right side view of a traditional framed sane home.

FIG. 11 shows rear/back of a traditional framed sane home.

FIG. 12 shows a first floor home plan of traditional framed sane home.

FIG. 13 shows a left side of traditional framed sane home.

FIG. 14 shows a front of traditional framed sane home.

FIG. 15 shows one embodiment of an electrical plan for a first floor of a traditional framed sane home.

FIG. 16 shows a further electrical plan for the first floor.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

Citation or identification of any document in this application is not an admission that such a document is available as prior art to the present disclosure.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

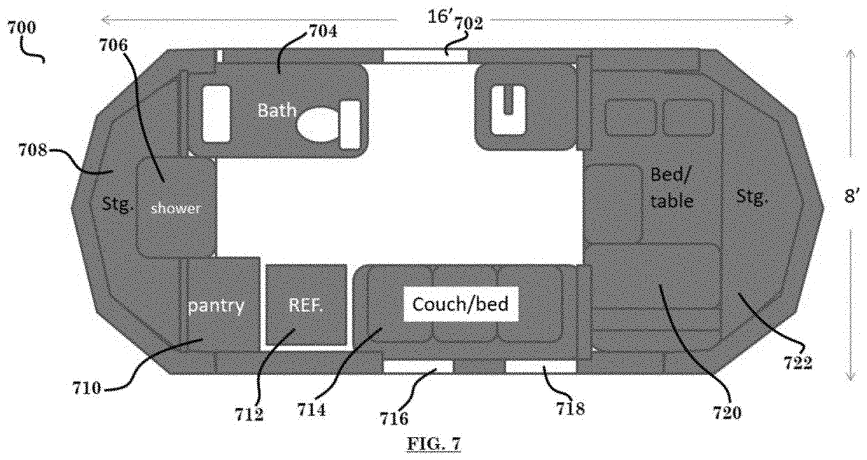

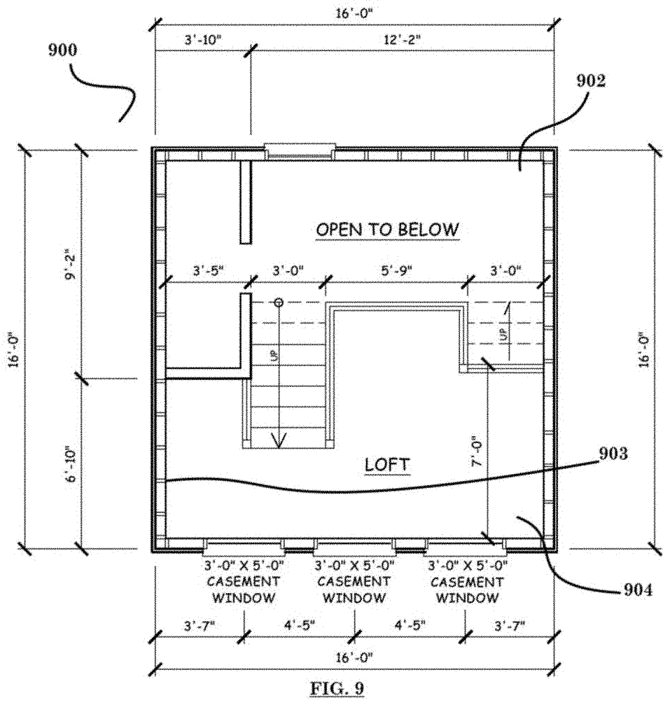

In 2015, the inventor, Michael R Weekes designed, fabricated and assembled a vehicle for dwelling he called Life Pod. The vehicle consisted of a cylinder capsule assembly fastened to a jet ski trailer. All components of the vehicle were cut out from plywood to make a range of flanges, joists and plates which fit together into panels and framework to create the floor, walls, roof and openings for door and windows. The capsule assembly consisted of a cylindrical core assembly (fuselage) and two dome shaped end cap assemblies. The Core was 8′ in diameter and made from ten panels arranges in a decagon cross-section. Each section had a (sandwich made from) 2×2 (1.5″×1.5″) framework, 1.5″ thick. Combined with sheets of polystyrene insulation and an exterior skin of ¼″ thick. Plywood. See FIG. 7. and FIG. 9.

The inner skin was also ¼″ luan plywood. The exterior plywood was coated with a heat-sealable TPO flexible roofing material from Carlisle SYNTEC® Systems. The dome end cap assemblies were made of the same 2×2 (1.5″×1.5″) framework and plywood (luan) skin. They each consisted of forty (40) ea. triangles (30 of an isosceles nature and 10 of an equilateral nature) arranged into a 2V or second frequency dome. The domes were fastened to the core and the entire assembly was heat-sealed to provide a water tight environment. A door and two hexagon shaped windows were added to provide access, egress and ventilation.

The Life Pod included a twin size mattress, a shower stall with shower head, compost toilet, kitchen counter with sink, portable propane stove and microwave oven. It also included a 30 gal. Water reservoir of non-potable water, water pump, pex plumbing and a 120V AC wiring harness with outlets and two incandescent lights and associated switches.

The Life Pod can be manufactured in a variety of sizes from 3′W×8′L up to 13.75′ W×26′L. Several Life Pods can be combined into clusters using a hub to achieve up to six pods per cluster. Pods can each have a variety of functions (dining, kitchen, sleeping, living, recreation, workspace, wellness, bath/toilet, etc.) or be dedicated to a certain function based on customer requirements to work in concert with other, adjacent pods.

The proof of concept (mobile) Life Pod (approx. 104 sq. ft.) was built in East Aurora, N.Y. between July and October of 2015 in a vacant warehouse on Pennsylvania Avenue by Michael R Weekes. It was taken in a test drive from Buffalo, N.Y. to Columbia, S.C. in November of 2015 and was stored at the Midlands Technical College Northeast Enterprise Campus for further outfitting.

In July 2016, Kirsten Dirksen, faircompanies.com/author/kirstendirksen, of Faircompanies.com visited the author in West Columbia, S.C. on Jul. 31, 2016 and made a documentary of Life Pod which has been viewed by more than 157,780 individuals on the popular web site:

YouTube: youtube.com/watch?v=5duPhZ491D8&t=25s

The book: Mobitecture, Architecture on The Move published on Apr. 17, 2017 by Rebecca Roke celebrated Life Pod on p 124.

Life pod revealed that a small family could be comfortable and have most of their needs met in a space from 200 to 400 sq. ft. This is validated in actual data from Asia and India and much of Europe. Building Life Pod inspired the author, Michael R Weekes to examine a permanent residential dwelling that would be permanently affixed to the ground.

Although Life pod was an amusing solution, it did not meet the requirements of the typical US resident seeking a residential dwelling. It did not meet HUD or international building codes for residential structures. Research continued from 2015 through 2020. This led to the search for an optimal module or system of building components that could achieve a wide range of living from 256 sq. ft. to 1,352 sq. ft.

In researching micro-living and self-reliant home design accomplishments, the author upon the work of Professor Mike Page at the University of Hertfordshire, UK and his QB2 house which measured 3 m (120″)×4 m (160″). But the QB2 house would not pass international building code in several areas including headroom on the loft level (requirement of 6′8″ minimum) as well as other structural dimensions. A unit 16′×16′×16′ high, however, delivers all the value of the Page cube home and also meets international building codes for residential construction.

The US Department of Energy Solar Decathlon (1990-2015) also provided examples of innovative thought to residential construction including Delta T 90 by Norfolk University, Indigo Pine by Clemson University, and Zerow House by Rice University. Each institution revealed how a net zero performance (a home that made, overall, all the energy it required to operate, over the year).

The Wikihouse Project managed by the Open Systems Lab in England also revealed the value of leveraging digital data to build computer-aided design (CAD) and computer-aided manufacturing (CAM) files along with CNC (computer numerical controlled) flat-bed routers to fabricate piece parts that interlock together to make parts and subassemblies that make residential structures.

The author built a 384 sq. ft (16′×16′) proof-of-concept structure in Walhalla, S.C. to verify his assumptions and validate measures and metrics related to livability. He lived in the structure for five months and monitored comfort and energy consumption. The result was the SANE (small, affordable, natural, energy-efficient) 384 sq. ft. house (affixed to a cinder block foundation).

The Small, Affordable, Natural Energy-Efficient Home (“SANE”), unlike a ranch style contemporary home, with a corridor that runs from the front, public or living side back to a bedroom, through a bath or kitchen along the way to a private side. The SANE 384 home is a large room, in essence with a loft. On your way up to the loft, the kitchen and bath are “attached to the perimeter of the room”, so each space is interconnected with every space and there is not separation of spaces as usually found with a hallway or passageway running from one room to another This allows for a tri-level environment where you move from one space to the other within feet of each other, yet, visually, each space maintains its own identity. Like a DNA strand, the home is three dimensional where each and every square foot is packed with flexible, value-delivering space.

An overall 16′×16′ maximum footprint, which should result in minimal or no waste in the fabrication and assembly of the dwelling

A lower, 12′ high window-free wall facing South and the high (16′) wall, dense with six (6 ea.) double hung windows facing North. There is one optional 18″×24″ double hung window on the East wall and two optional full size double hung windows on the West wall.

The sloping (3/12) roof faces up to meet the sun in the southern hemisphere with exposure to 32 degrees to 78 degrees, depending on the season to maximize the number of light-hours and efficiency of the solar (PV) panels. Using an optional three (3 ea.) 350 W, 80 A, 48V solar (PV) solar panels, associated bracketry and interconnecting wiring harnesses and an associated inverter and charge controller along with four (4 ea.) 12V batteries, a net zero, off grid or grid tie capability could be achieved should the occupant/residents require a more sustainable arrangement.

Some features of a home of the current disclosure may be a 16′ maximum roof height, a metal roof made from GALVALUME® or equivalent, capable of holding one to three occupants, maintains a comfortable temp. (68 deg. F.+/−5 deg.), adequate food preparation/kitchen and dining space, adequate bathroom, adequate living/dining space, a kitchen space including stove, oven, sink and refrigerator, a clothes washer and dryer, a toilet, a shower, and a living dining space which could convert into an additional sleeping area.

Heating, cooling and ventilation is achieved with a 9,200 BTU cooling and 8,500 heating capacity packaged terminal air conditioner (PTAC) with two stage compressor or equivalent, with energy efficiency ratio of 11.6, 310 CFM flow and 2.2 pints per hour moisture removal/dehumidification and 400 sq. ft. capacity. The PTAC makes up for the air-tight nature of the structure by making up the air every 0.6 hrs.

The structure would include minimal or no windows on the West, East and South side of the building to reduce the solar heat load into the building in the hot, humid shouter climate zones

The North wall of the structure, the 16′ high wall would maximize window surface area to allow passive light to provide lighting for residential living tasks with minimal carbon footprint/energy consumption.

All windows should be of low-e specification.

All appliances should be of energy star rating or better.

The interior would consist of a main first floor, an elevated kitchen and bath living level approx. 28″ or four standard steps up from the main living level and a third level, approx. 84″ or 12 steps up from the kitchen/bath level.

The elevated kitchen/bath level creates storage capacity of up to 186 cu. Ft. for storage of pantry, toiletries, clothing, sporting goods and other belongings the resident may need as a result of down-sixing from a larger dwelling.

This results in a residential structure that requires the minimal energy to heat or cool or makeup fresh air, as it resembles a “room with a loft” configuration.

Extra insulation is installed (9″ thick) Wall, resulting in R values of 45

Extra insulation is installed (12″ thick) Roof module resulting in an R value of approx. 55.

It is encouraged to use a structurally insulated panel (SIP) type wall in order to reduce construction style time and take advantage of modular construction approach.

An air and moisture wrap is fastened to and covers the entire floor, wall and roof, creating a virtual air-tight envelope, so a PTAC type heating and cooling unit.

There is an option for a solar hot water system. Solar hot water systems capture thermal energy from the sun and use it to heat water for your home. These systems are made of a few major components: collectors, a storage tank, a heat exchanger, a controller system.

Up to three solar hot water elements connected to an 80 gal. highly insulated water reservoir, upstream of an on-demand hot water heating element recommended.

Cement slab foundation (4 in. depth) can be replaced with crawl space of approximately 18″ height with ventilation.

Walls were insulated using a byproduct of the cotton ginning process called MOTE. MOTE is cotton with strands that are insufficient to be used at the loom downstream but contains all the insulating value of long-strand cotton. There is also a small amount of debris (leaves, trigs segments, dirt, in the MOTE. One 520 lb. bale of MOTE was purchased to insulate the four walls and roof of the Sane home prototype. The cotton byproduct was mixed with Borax® detergent, containing boron, a mineral called sodium tetraborate, which is free of phosphates, chlorine and other chemicals, which discourages insects, mold, rot and mildew. The average resultant R Value was 9 was achieved using an average of 3 in. of materials in the walls and roof.

The current disclosure is different from conventional stick frame construction in myriad ways. It is smaller, based on a module of 384 sq. ft. which can be executed in a multiple of modules up to 1,536 sq. ft. (in a 4-module solution), requiring less cost, less capital, less of a supply chain, less carbon footprint and less greenhouse gas consumption. The median family home is the United States in 2020 was 2,180 sq. ft. It is easier to take care of as you can assess the state of the home on a glance, as it is practically a large room with a loft. There is less maintenance and less things to break or fix. It leverages the sun, by being oriented in a way to maximize passive light on the North wall and minimal windows on the East, South and West walls. It is heavily insulated (with wall R values in the range of 45 and roof R values in the range of 55) requiring less energy to heat, cool, de-humidify or keep cool or warm, as required. It is airtight and utilizes a secondary compressor in a PTAC HVAC system to maximize comfort and maximize fresh air exchanges. It uses low-e windows to further reduce cost of operation. It uses energy Star® rated appliances (over, stove, microwave, refrigerator, washer/dryer); excludes a dishwasher; and represents little travel to live in. It maximizes the use of materials like plywood, which are locally sources, reducing delivery/transport carbon footprint. This plywood polygon based wall panel configuration is more stable than lumber and made from low carbon footprint forestry processes and sources.

The Economic ROI of a Smaller Prefabricated Modular Home is evident.

Cost to manufacture the SANE 384 home ranges from $169-199/sq. ft. Pricing of the SANE 384 ranges from $79,900 to $229,000 while the median home in the United States in 2019 was $287,284 to 274,000. This creates a whole new market segment for developers seeking to satisfy the housing needs for a first time homebuyer, 80% plus median family income single family residential communities globally. Less expensive homes make homeownership available to those previously kept out of the mortgage market due to their lower incomes or lower credit scores. Investors in a smaller, prefabricated, mass-produced home solution can experience competitive returns, especially as conventional markets become increasingly unstable.

The benefits of the SANE home include use of locally sourced materials, minimizing carbon footprint in the supply chain, purchasing phase of execution. Low carbon footprint plywood that leverage quick growth forestry and reuse of scrapped materials, recycled materials. Manufactured in a micro-factory in controlled environments, little of any materials is damaged by weather, heat, rain or humidity that commonly occurs in conventional 6 months to 9 month stick frame construction. New living wage jobs are created by making smaller, efficient homes vie prefabricated mass manufacturing methodology. New advanced manufacturing jobs also result. New capital investment results from this new methodology. Higher tax revenues are the result of these new, higher paying jobs. SANE 384 houses are assembled in days, not months, requiring less energy, labor and cost, creating a lower cost home. The lower cost enables a lower price and associated mortgage required by the home-buyer/owner, enabling those previously unqualified for higher-priced homes to achieve home ownership.

The cube shape is much more efficient than a longer, rectangular typical home, which has more walls and barrier to air flow, heat travel and removal of heat, when required. Use of low-e double hung windows contribute to a lower cost operation of the home. Use of energy Star® rated washer, dryer, refrigerator and on-demand water heater will further contribute to a lower cost of operation of the home.

The SANE 384 House requires up to 67% less energy to live in/operate. Residential housing is responsible for 22% of our global warming/exponential growth in recorded carbon dioxide. Investment is this type of solution could have global positive impacts.

The orientation of the home with respect to the solar trip through the southern hemisphere makes it suitable to leverage renewable energy through solar (PV) panels.

The air tight envelope accompanied by recovery ventilation via the PTAC system creates a home uses less energy to keep within the comfort zone (68 degrees F.+/−5 degrees) that is healthier to the occupant with a fresh air exchanges every 0.6 hours.

A whole new segment/market of home-owner means a whole new segment/market of small mortgages.

Home owners take better care of their homes compared to renters, who have no real vested interest in taking care of the structure.

New homes mean more, safe, sanitary housing available to those previously inhabiting less-than-adequate housing managed by others.

Home ownership created equity and wealth raising the socio-economic status of the resident creating wealth for their offspring.

These and other aspects, objects, features, and advantages of the example embodiments will become apparent to those having ordinary skill in the art upon consideration of the following detailed description of example embodiments.

Geome LLC leverages a new movement where digital files are created to fabricate parts for the home. Instead of using traditional stick-frame methodology to build a home, the home is looked at as a system of parts.

Data is created as a result of the computer aided design (CAD) and CAM files are used to fabricate parts on CNC flatbed routers.

Geome LLC uses a network of fabricator/makers across the United States to optimize the supply chain. Carolina Handcrafted Woodworks (CHW) in Lexington, S.C. is part of this national network. CHW is our strategic partner at Geome LLC. Geome LLC had the dream of delivering truly affordable, sustainable housing to those least among us. We work with CHW to turn our sketches into CAD and CAM files. CHW fabricates parts that Geome LLC assembles and delivers to the job site. Homes are constructed in weeks, not months. Materials don't sit out in the weather and deteriorate. There is no work-in-process-inventory. Parts are made when they are needed, and not before.

Traditional manufactured homes are made in large factories which are far from the client or customer. Homes are made by hundreds of employees in facilities where as many as ten homes can be built in one day. The focus is on quantity, not quality. Although these homes comply with HUD (US Department of Housing and Urban Development) they have a reputation for shoddy workmanship.

Geome LLC Homes are made in smaller workshops, with the emphasis on quality. Being built under a roof, out of the weather, in well-lit facilities, Geome LLC homes represent better workmanship. Computer aided processes use specific information to fabricate very exact, accurate parts (Typically +/− 1/32″, within material variation). The assembly process is predictable, repeatable and without defect.

Large factories building traditional homes seldom record or respond to defects so mistakes are made over and over, leading to a reputation for poor quality in the traditional manufactured (mobile) home.

Like a piece of IKEA cabinetry, your Geome Home goes together with instructions, You can even build your own home!

Standard sheets of 4′×8′ plywood are loaded onto the flat bed router. Computer files are loaded onto the router. Parts are precisely cut out of the sheet, numbered and serialized to trace their date of manufacture. Parts are assembled or loaded onto pallets for shipment to the job site. Unlike typical lumber used with stick frame assembly, there is no measuring, less opportunities for error or defect. In sort, there is only one way you build the house and it is all laid out in the instructions.

Geome LLC offers four workshops every year to allow up to six couples to help another Geome Home Owner the opportunity to build their home, gaining confidence that they, too have what it takes to build their own home. Call Mike at Geome LLC today at 828 378 4090 to register for the next workshop.

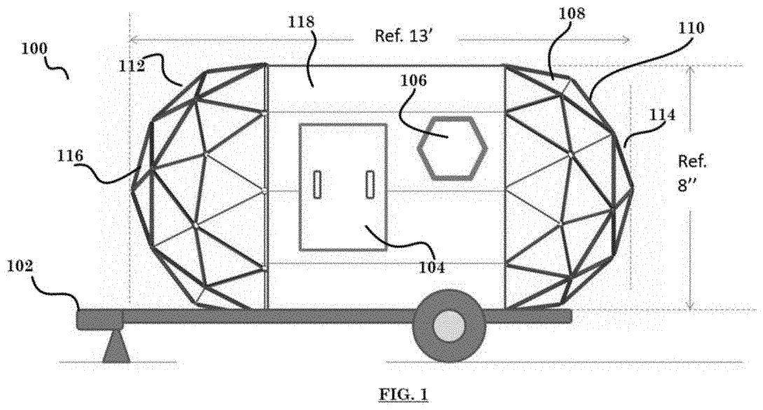

FIG. 1 shows one embodiment of a smaller home 100 of the current disclosure. As FIG. 1 shows, smaller home 100 may be designed to be transported by a trailer 102 or other carry-behind type conveyance such as a goose neck trailer, flat bed, etc. Smaller home 100 may be designed to have a door 104 and window 106 as well as have a geodesic design 108 at opposing ends 110 and 112 of smaller home 100 for both space optimization and esthetics purposes. In one instance, and not intended to be limiting, smaller home 100 may have a height of 8 feet and a length of 13 feet. In other embodiments, smaller home may range in height from 6 feet to 12 feet and range in length from 10 feet to 16 feet, including variations between these ranges. This enables the home to fit in very small spaces, as well as take up a minimal physical footprint, while still providing viable living space. First end 114 and second end 116 of smaller home 100 may be formed with a particular geodesic shape and made with removable/adjustable tiles as explained infra. Wall 118 and the opposing wall, not shown, may also be formed of the tiles discussed infra.

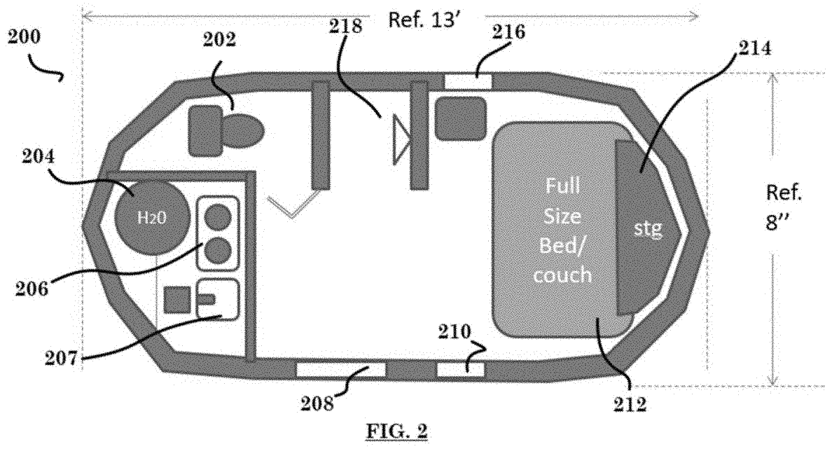

FIG. 2 shows a top down view of an exemplary floor plan 200 of smaller home 100. As plan 200 shows, the home may include a toilet 202, water container 204, such as a hot water heater or cistern, a stove 206, sink 207, door 208, first window 210, a couch/bed combination 212, a platform or stage 214 for storage, etc., second window 216, and a closet 218.

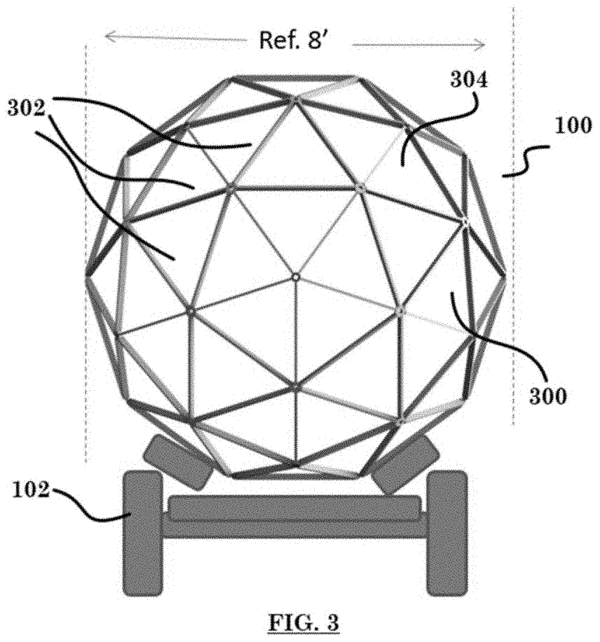

FIG. 3 shows a rear view of smaller home 100. This view shows that both ends, front not shown in this view, may be made in a dome shape 300 possessing a tiled pattern 302. While shown as triangular in FIG. 3, any particular shape such as square, rectangular, polygon, circular, oval, random shaped, star shaped, etc., may be used for tiles 304.

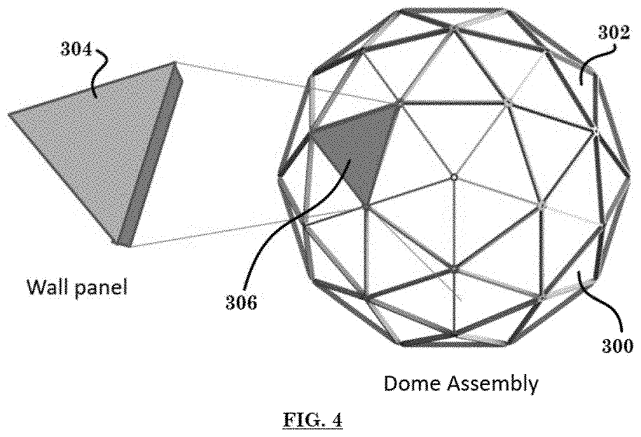

FIG. 4 shows an close-up view of dome shape 300 with one tile 304 removed from tiled pattern 302 revealing tile holding space 306.

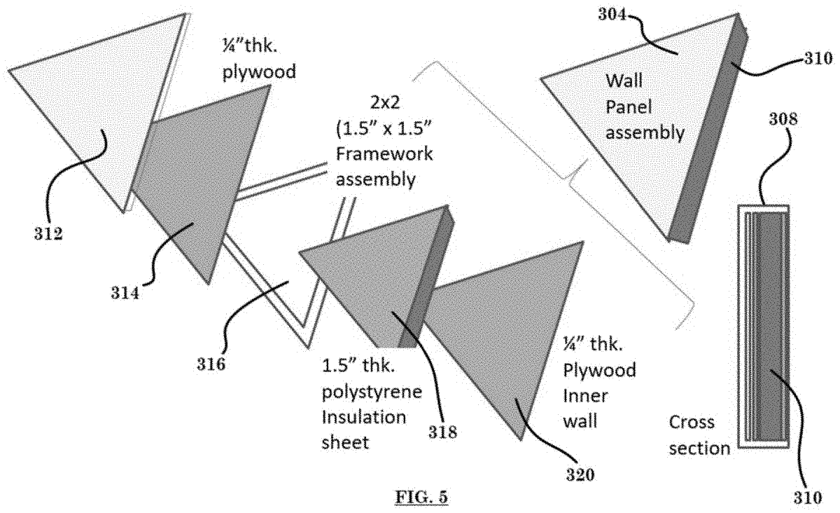

FIG. 5 shows an exploded view of tile 304. Tile 304 may be multilayer layered to form a multilayered stack configuration 308 for interior 310 of tile 304. The multilayered stack configuration 308 of tile 304 may include a durable outer shell 312, such as SYNTEC® available from CARLISLE, Carlisle, Pa. 17013, thin concrete coating sheets, metals, polymers, synthetics, durable nonwovens, etc., a first inner layer 314, which may be wood, such as plywood, metals, plastics, synthetics, durable nonwovens, etc., a second inner layer 316 which may be a framework, made from metal, wood, plastic, or synthetics for providing strength and stability to multilayered stack 308, a third inner layer 318, which may be an insulation layer such as polystyrene or other insulation products as known to those of skill in the art, and a fourth inner layer 320, which may also be wood, such as plywood, metals, plastics, synthetics, durable nonwovens, etc. While multilayered stack 308 is shown with five layers, more or less layers, such as 1, 2, 3, 4, 6, 7, 8, etc., should be considered disclosed as if set herein verbatim. The multilayered formation to multilayered stack 308 may be varied from climate to climate to allow smaller home 100 to be used in a plethora of environmental conditions. I.e., more insulation may be added in hot or cold climes, less in temperate climates, more framework layers may be added for strength in high-wind or turbulent environs, etc.

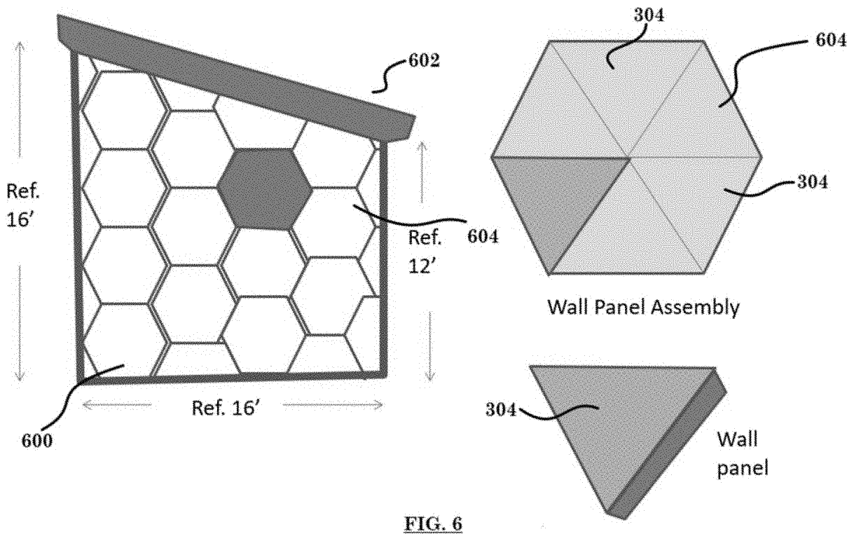

FIG. 6 shows an alternate embodiment of wall 600 that may be employed for a differently shaped smaller home 602, which may be shaped like a shed or smaller form of a traditional home wall. Wall 600 may also be composed of tile pattern 302 comprised of tiles 304 as discussed supra, which may be formed into multi-tile assemblies 604. While tile assembly 604 is shown comprising six tiles, more or less layers, such as 1, 2, 3, 4, 5, 7, 8, etc., should be considered disclosed as if set herein verbatim. Further, wall 600 may be employed as one or more walls of the embodiments shown starting at FIG. 9.

FIG. 7 shows alternative smaller home 700, which may have larger dimensions such as being 16 feet long and 8 feet wide and 8 feet high. Alternative smaller home 700 may include door 702, bath 704 (accommodated via the larger home size), shower 706, first stage 708 for storage, pantry 710, refrigerator 712, first couch/bed 714 (such as a futon, folding bed, collapsible wall unit bed/couch, etc.), first window 716, second window 718, and second bed/couch 720, that may double as a table, and second stage 722.

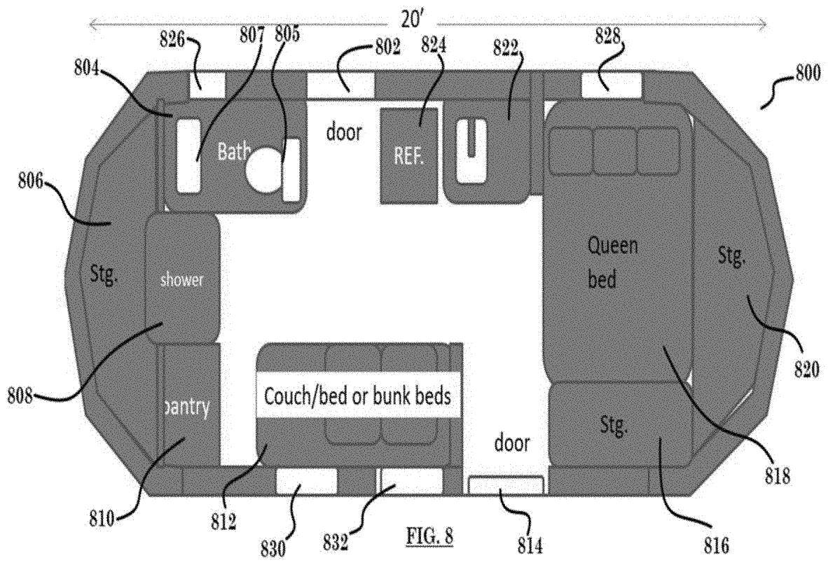

FIG. 8 shows a further smaller home 800 that may include door 802, bathroom 804, which may include a toilet 805 and sink 807, first stage 806, shower 808, pantry 810, couch/bed 812 (that may be a single bed or form a bunk bed, second door 814, second stage 816, a fixed bed 818 that may be a large bed such as a queen or king sized bed, third stage 820, sink 822, refrigerator 824, first window 826, second window 828, third window 830, and fourth window 832. Exemplary dimensions for this still larger smaller home 800 may be 20 feet in length, while maintaining width at 8 feet and maintaining height at 8 feet and/or increasing same.

FIG. 9 shows an alternative floor plan for a traditional framed sane home 900. As the floor plan shows, the footprint of the home is still small measuring approximately 16 feet wide by 16 feet long with FIG. 9 shows a potential loft 902 configuration 904 and inner perimeter 903.

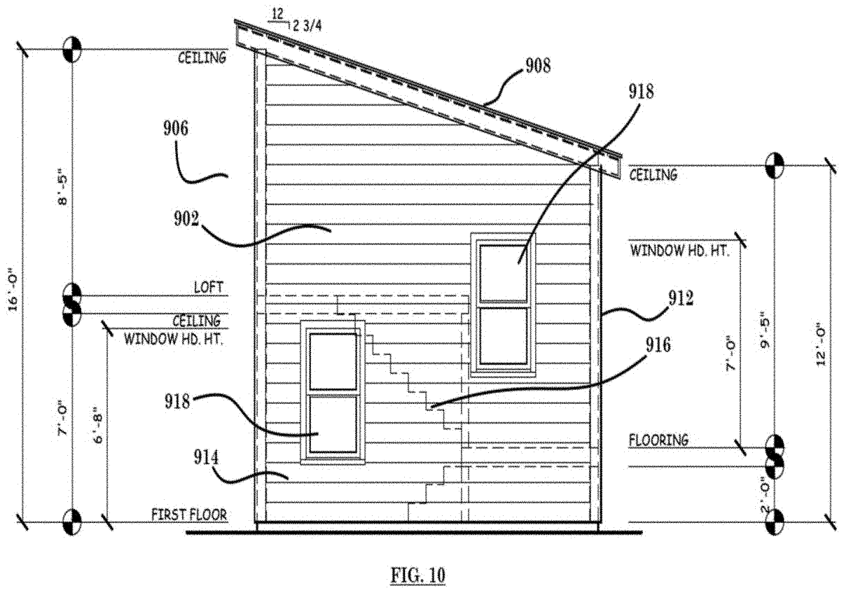

FIG. 10 shows a right side 906 view of traditional framed sane home 900 have a sloped roof 908, due to the slope front 910 of traditional framed sane home is substantially 16 feet high while the back 912 slopes to be 12 feet high, again, providing for a smaller home footprint, requiring less materials to build, while still creating a comfortable living space. Loft 902 may be accessed from first floor 914 via loft ascending stairs 916, shown in dashed lines, windows 918 maybe placed in right side 906 wherever deemed aesthetically suitable or to enable maximum viewing from the interior of traditional framed sane home 900.

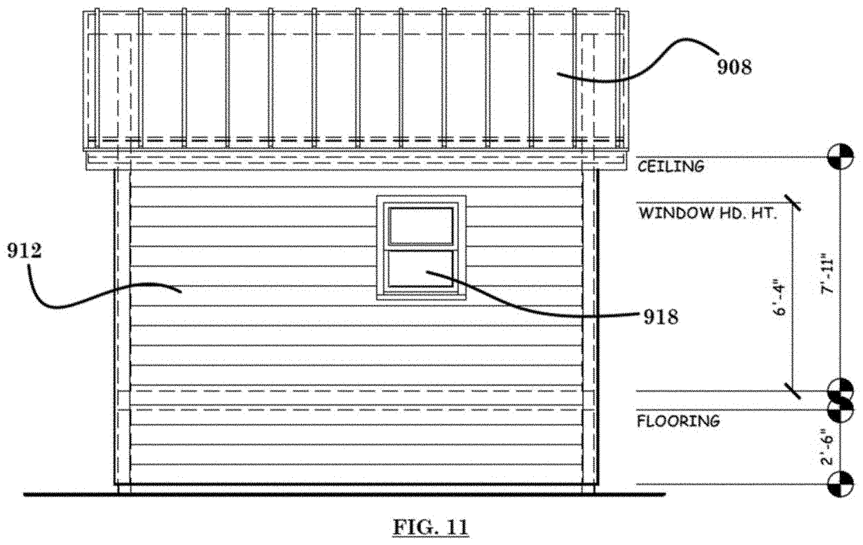

FIG. 11 shows rear/back 912 of traditional framed sane home 900.

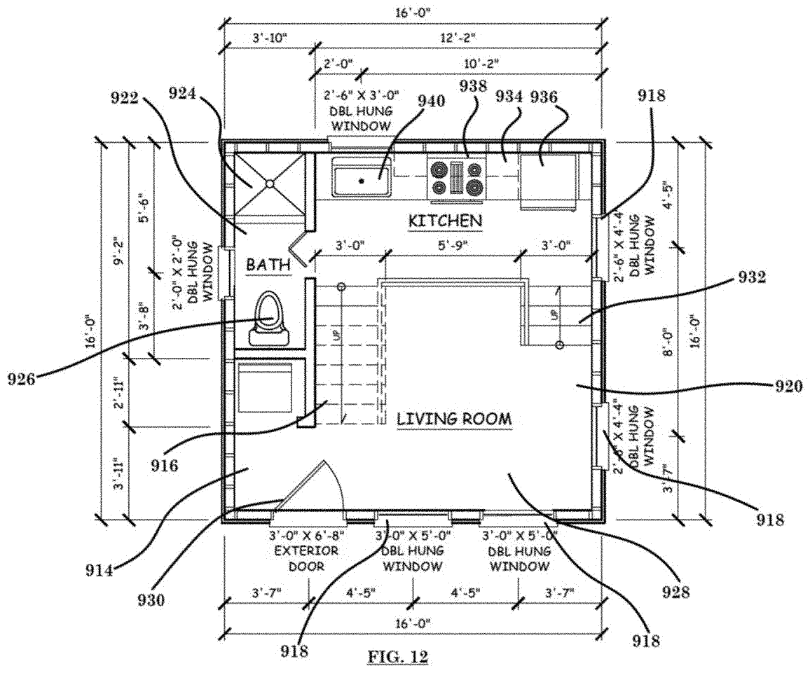

FIG. 12 shows a first floor 914 home plan 920. As the plan shows, traditional framed sane home 900 may be built as a 16 foot square containing a bathroom 922, shower 924, toilet 926, living area 928, windows 918, loft ascending stairs 916, first floor stairs 932, kitchen 934, refrigerator 936, stove 938, and sink 940.

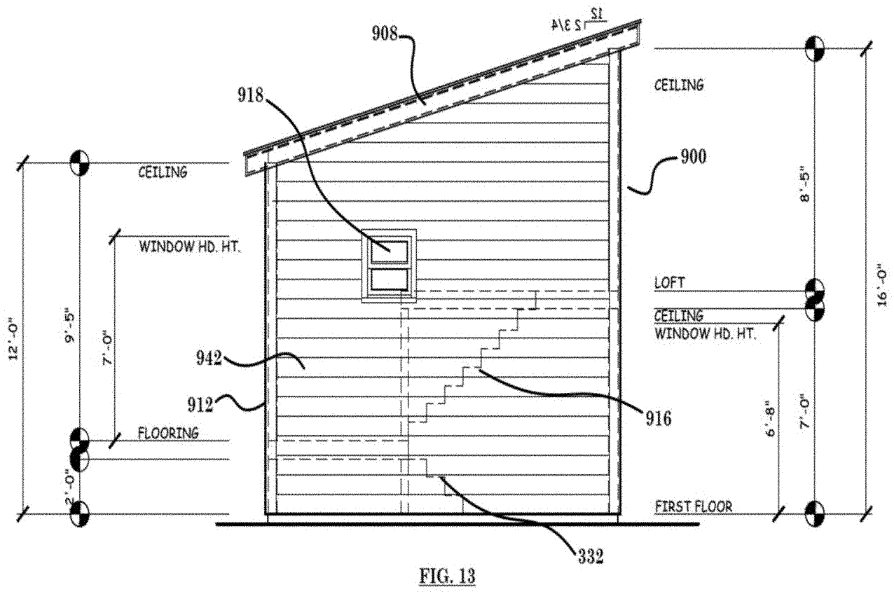

FIG. 13 shows left side 942 of traditional framed sane home 900.

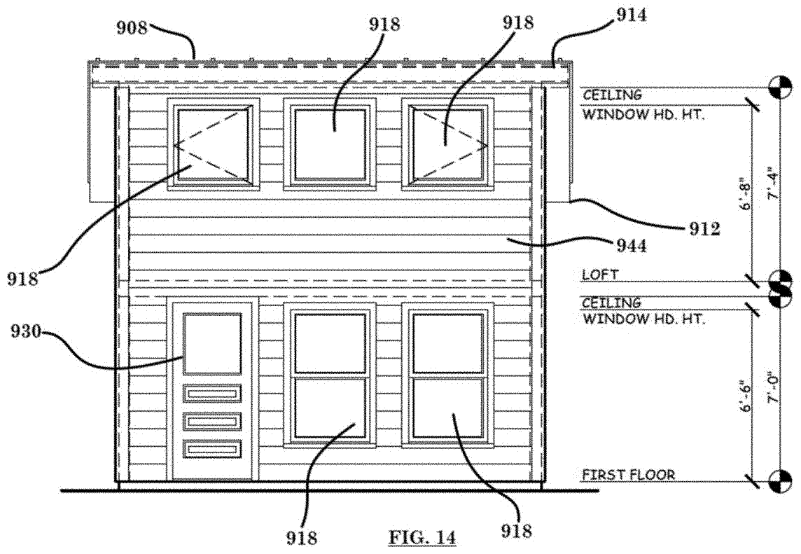

FIG. 14 shows front 944 of traditional framed sane home 900.

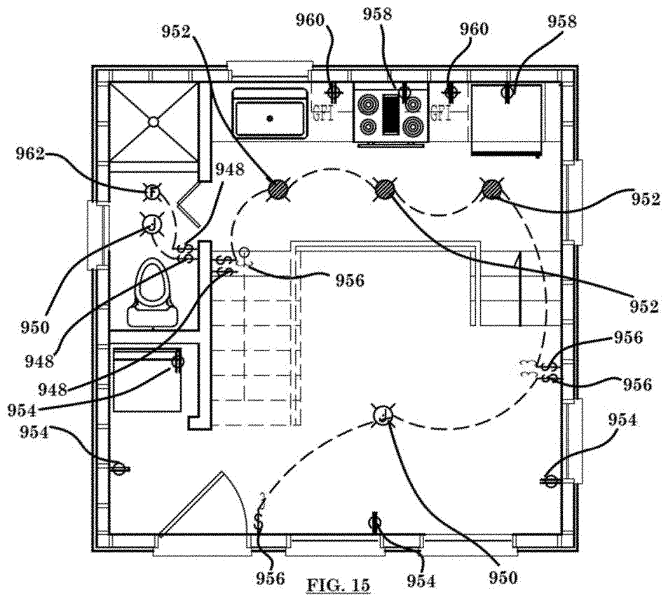

FIG. 15 shows one embodiment of an electrical plan for first floor 914 of traditional framed sane home 900. Electrical plan 946 may include single pole switches 948, light fixture junction boxes 950, recessed lights 952, switched duplex receptacles 954, two way switches 956, 220 volt receptacles 958, ground fault interrupters 110 volt 960, and a ceiling mounted exhaust fan 962.

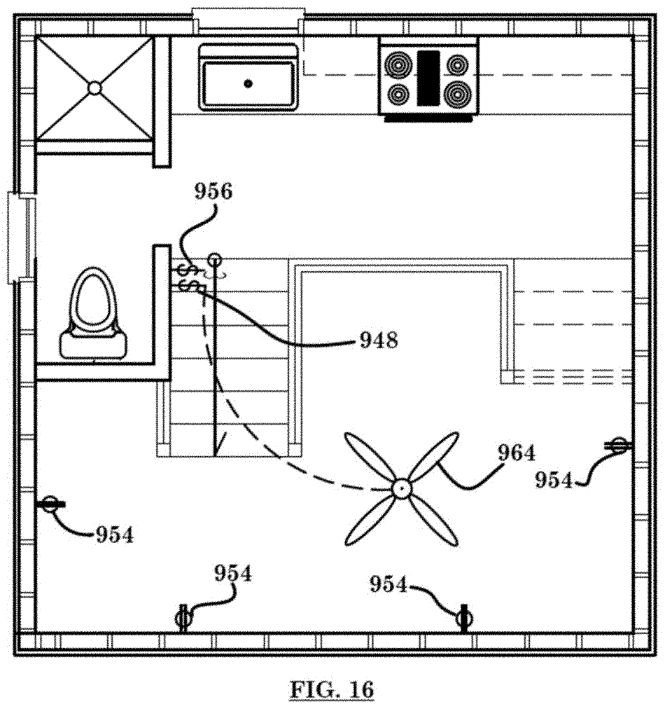

FIG. 16 shows a further electrical plan for first floor 914 including a ceiling fan 964.

The homes provide comfort as well as lower costs via orientation of south-facing roofs at a 3/12 pitch, smaller homes with open concept to maximize air flow and circulation, solar (PV) panels on the roof (up to 4 kwh for 750 sq. ft. home), higher insulation—R values of 38 and above than typically used in construction, an air tight envelope, heat recovery ventilation—more frequent fresh air, heat pumps which use less energy to cool and heat the home, low-e windows that reflect the UV and let passive light in, energy star appliances, and hot water systems powered via solar power, with larger storage.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. An engineered small home comprising;
a living room formed on a floor of the engineered small home;
an elevated bathroom raised above the living room;
an elevated kitchen raised above the living room;
a loft connected to the living room via stairs and raised above the living room, elevated kitchen and elevated bathroom;
wherein the loft, elevated bathroom and elevated kitchen are attached to an inner perimeter of the engineered small home and the living room, loft, bathroom, and kitchen are interconnected without being separated by hallways;

2. The engineered small home of claim 1, wherein the engineered small home comprises a slanted roof with an exterior front wall higher than an exterior rear wall and the slanted roof running between the exterior front wall and the exterior rear wall.

3. The engineered small home of claim 1, wherein an exterior of the engineered small home measures no more than sixteen feet in length, width and height.

4. The engineered small home of claim 2, wherein the exterior rear wall is window free to reduce solar heat load.

5. The engineered small home of claim 4, wherein the exterior rear wall is oriented to face South and orients the slanted roof to face South.

6. The engineered small home of claim 1, further comprising the exterior front wall containing at least one window.

7. The engineered small home of claim 1, further comprising wherein the elevated bathroom and elevated kitchen include storage spaces below each adjacent to a floor of the engineered small home.

8. The engineered small home of claim 1, further comprising a 9,200 BTU cooling and 8,500 BTU heating capacity terminal air conditioner.

9. The engineered small home of claim 1, further comprising a wrap covering the floor, all walls, and the roof to create a substantially air-tight envelope.

10. The engineered small home of claim 1, further comprising insulation comprising Boron to deter bugs, rodents, germs and mold.

11. The engineered small home of claim 1, further comprising at least one solar panel placed on the slanted roof running a length of the slanted roof.

12. The engineered small home of claim 1, further comprising wherein the at least one solar panel powers a hot water system for the engineered small home.

13. The engineered small home of claim 1, further comprising at least one wall formed from at least one tile creating a tiled pattern on the at least one wall.

14. The engineered small home of claim 1, further comprising wherein the at least one tile is multilayered to form a multilayered stack configuration.

15. The engineered small home of claim 1, wherein the multilayered stack configuration composition varies from one environ to another environ to adjust the engineered small home to an environ where it is placed.
